(19) United States
(12) Patent Application Publication
(10) Pub. No.: US 2025/0181732 A1
(43) Pub. Date: Jun. 5, 2025

(54) LIMITING DEVICE FEATURES BASED ON USER AUTHENTICATION

(71) Applicant: MOTOROLA SOLUTIONS, INC., Chicago, IL (US)

(72) Inventors: Richard Nelson, Tamarac, FL (US); Gurpreet Dhaliwal, Palatine, IL (US); Brian J. Frommelt, Naperville, IL (US); Kiesha Diane Grant, Sunrise, FL (US)

(21) Appl. No.: 18/527,811

(22) Filed: Dec. 4, 2023

(51) Int. Cl. G06F 21/60; G06F 21/31

(52) U.S. Cl. CPC G06F 21/604; G06F 21/316; G06F 2221/2141

(57) ABSTRACT

Systems and methods for controlling use of a device having a plurality of operating features based on authentication of a user. The system includes an electronic processor communicatively coupled to an identification device. The electronic processor is configured to receive, from the identification device, a first characteristic of the user, and determine, based on the first characteristic of the user, whether the user is a primary user. The electronic processor is configured to determine, in response to failing to determine that the user is the primary user, a current operating pattern of the user, receive, in response to the user not being the primary user and from the identification device, a second characteristic of the user, and limit access to a subset of the plurality of operating features of the device based on the current operating pattern of the user and the second characteristic of the user.

### BACKGROUND

Agencies and enterprises own vehicles, heavy machinery, and other devices that are designed to be used by specific, authorized users. These vehicles and other devices may also include features such as tablets, laptop computers, desktop computers, telephones (for example, cellular, landline, or satellite), devices with an interactive display, other communication devices, and combinations thereof that provide users with instant access to increasingly valuable information, resources, capabilities, and databases. Should these vehicles, heavy machinery, and other devices be accessed by unauthorized users, misuse, damage, and preventable harm may occur.

### BRIEF DESCRIPTION OF THE DRAWINGS

FIG. 1 is a block diagram of a communication system according to one example.

FIG. 2 is a block diagram of a command center included in the communication system of FIG. 1 according to one example.

FIG. 3 is a block diagram of a device included in the communication system of FIG. 1 according to one example.

FIG. 4 is a block diagram of a memory of the device of FIG. 3 according to one example.

FIG. 5 is a flowchart of a method performed by the device of FIG. 3 according to one example.

FIG. 6 is a flowchart of another method performed by the device of FIG. 3 according to one example.

FIG. 7 is a block diagram of a parallel logic test performed by the device of FIG. 3 according to one example.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Many vehicles, heavy machinery, and other devices are designed to be used by specific, authorized users. However, at times, unauthorized users may gain access, whether accidentally or intentionally. These instances may result in misuse and preventable harm. For example, during a public safety incident a person of interest may gain access to a public safety vehicle. Such access may result in confusion and/or injury to surrounding civilians.

Thus, there is a need for authorizing users of electronic devices, such as vehicles, prior to allowing full access to features of the vehicle. For example, identification devices are used to identify a user. When the user is authorized, operation of the device is permitted. However, should the user be un-authorized, operation of the device is disabled. In some instances, the device may permit different levels of authorization. For example, a primary authorized user may have complete access to all features of the device. However, a secondary authorized user may have access to driving controls of the device while other features of the device are disabled (for example, communication features).

In some instances, an authorized user may gain access to the device, but should be limited in their access when impaired or when operating outside of prescribed guidelines. For example, an impaired driver should not be permitted full access to a vehicle. When the authorized user is determined to be impaired or operating outside of prescribed guidelines, the device may limit the operating features available to the user. Once the user is authorized, the device may continue to repeatedly authorize the user to confirm the authorization, and may continue to determine whether the user is operating within prescribed guidelines.

In some instances, when an unauthorized user or an impaired user is detected, the vehicle enters a notification mode. In the notification mode, the vehicle transmits that the device is being accessed by the unauthorized user to devices within a shared network. For public safety devices, the device may be tracked on a map of a dispatch console, and incoming and outgoing communication between the device and other public safety devices may be limited.

One example provides a system for controlling use of a device having a plurality of operating features based on authentication of a user. The system includes an identification device configured to identify characteristics of the user of the device. The system also includes an electronic processor communicatively coupled to the identification device. The electronic processor is configured to receive, from the identification device, a first characteristic of the user, and determine, based on the first characteristic of the user, whether the user is a primary user. The electronic processor is configured to determine, in response to failing to determine that the user is the primary user, a current operating pattern of the user, and receive, in response to the user not being the primary user and from the identification device, a second characteristic of the user. The electronic processor is configured to limit access to a subset of the plurality of operating features of the device based on the current operating pattern of the user and the second characteristic of the user.

Another example provides a method for controlling use of a device having a plurality of operating features based on authentication of a user. The method includes receiving, from an identification device configured to identify characteristics of the user of the device, a first characteristic of the user, and determining, based on the first characteristic of the user, whether the user is a primary user. The method includes determining, in response to failing to determine that the user is the primary user, a current operating pattern of the user, and receiving, in response to the user not being the primary user and from the identification device, a second characteristic of the user. The method includes limiting, based on the current operating pattern of the user and the second characteristic of the user, access to a subset of the plurality of operating features of the device.

Each of the above-mentioned examples will be discussed in more detail below, starting with example system and device architectures of the system in which the examples may be practiced, followed by an illustration of processing blocks for achieving an improved technical method, device, and system for time-multiplexed illumination blending.

Examples are herein described with reference to flowchart illustrations and/or block diagrams of methods, apparatus (systems) and computer program products according to example examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

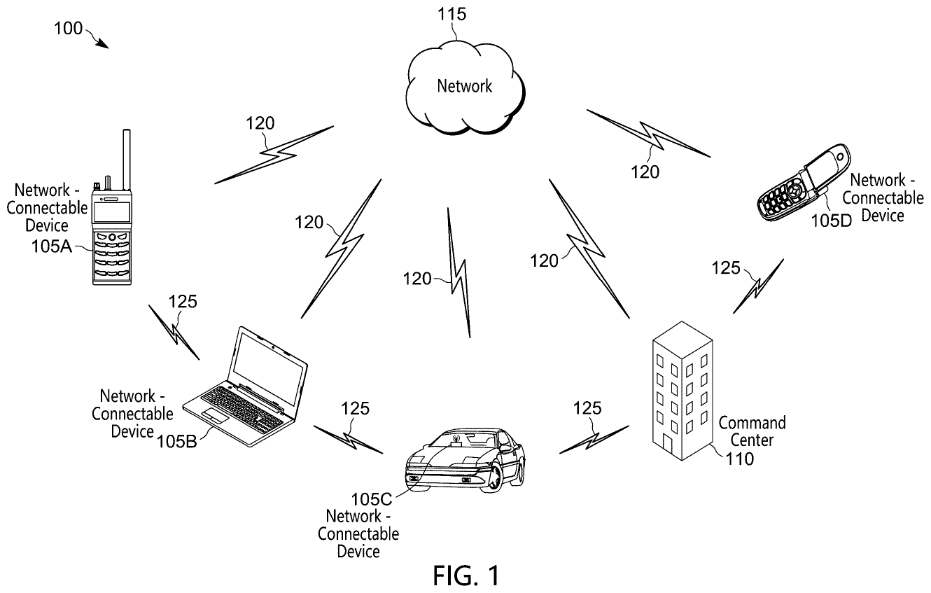

Referring now to the drawings, FIG. 1 is a block diagram of a communication system 100 according to one example embodiment. The communication system 100 includes various network-connectable devices 105A through 105D. In the following description, when explaining how a single network-connectable device functions, a reference to network-connectable device 105 is used. As indicated by FIG. 1, the network-connectable device 105 may be any one of a number of different types of network-connectable devices. For example, network-connectable device 105A is a portable communication device carried by an officer during patrol (for example, an employee of a theme park; a security guard at a concert or sporting event; a public safety officer such as police officer, firefighter, and paramedic; and the like). In some embodiments, network-connectable device 105A is a smart phone, a battery powered portable radio, a body wearable camera, a biometric sensor, or similar device. As another example, network-connectable device 105B is a laptop computer that can receive input from a user via a keyboard, a touchscreen display, a microphone (for example, voice commands), and the like. In other embodiments, network-connectable device 105B is a tablet, a desktop computer, or a similar device. As another example, network-connectable device 105C is a vehicle (for example, a police vehicle, a fire truck, an ambulance, a maintenance vehicle such as a tow truck, and the like). Network-connectable device 105C may include, but is not limited to, a dashboard camera, a mobile radio, a microphone, a laptop, and the like. As yet another example, network-connectable device 105D is a smart phone operated by a civilian. Network-connectable device 105D may be any type of network-connectable device (for example, a laptop, desktop computer, tablet, smart watch, and the like).

The types of network-connectable devices 105A through 105D described above and shown in FIG. 1 are merely examples. In other embodiments, the communication system 100 includes other types of network-connectable devices. In some embodiments, the communication system 100 includes more or fewer network-connectable devices 105 than the quantity of network-connectable devices 105 shown in FIG. 1.

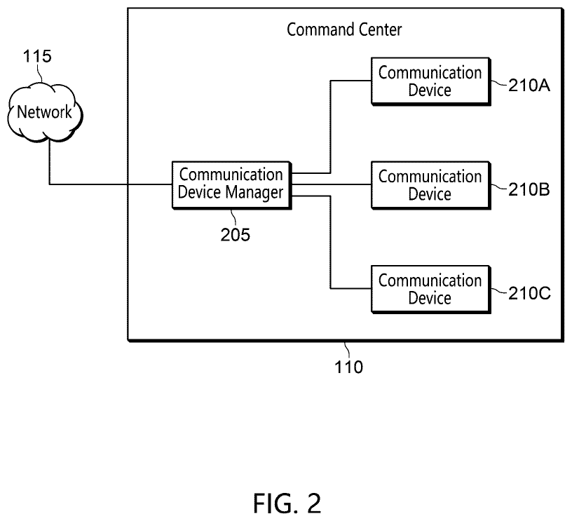

As shown in FIG. 1, the communication system 100 also includes a command center 110. For example, the command center 110 is a security management office at a theme park or other commercial enterprise, or a public safety command center such as a police headquarters, fire station, dispatch center, public safety answering point (PSAP), operations center, command and control facility, and the like. In some embodiments, the command center 110 includes one or more network-connectable devices 105 that are part of the communication system 100 as explained below with respect to FIG. 2. In the following description, when explaining communication to or from the command center 110, it should be understood that such communication is occurring to or from one or more of the network-connectable devices 105 included in the command center 110.

As indicated in FIG. 1, the network-connectable devices 105A through 105D and the command center 110 may communicate with each other over a network 115 over respective wireless links 120 and via corresponding network interfaces including one or more transceiver circuits (for example, by sending and receiving radio signals). The network 115 may include wireless and wired portions. All or parts of the network 115 may be implemented using various existing networks, for example, a Land Mobile Radio (LMR) network, the Long Term Evolution (LTE) (including LTE-Advanced or LTE-Advanced Pro compliant with, for example, the 3^{rd} Generation Partnership Project (3GPP) Technical Specification (TS) 36 specification series), or the 5G (including a network architecture compliant with, for example, the 3GPP TS 23 specification series and a new radio (NR) air interface compliant with the 3GPP TS 38 specification series) standard, among other possibilities, and over which multimedia broadcast multicast services (MBMS), single site point-to-multipoint (SC-PTM) services, or Mission Critical Push-to-talk (MCPTT) services may be provided, or over which an open mobile alliance (OMA) push to talk (PTT) over cellular (OMA-PoC), a voice over Internet Protocol (IP) (VoIP), or a PTT over IP (PoIP) application may be implemented. The network 115 may also include future developed networks. In some embodiments, the network 115 may also include a combination of the networks mentioned.

Also as shown in FIG. 1, in some embodiments, the network-connectable devices 105A through 105D and the command center 110 may communicate directly with each other via direct-mode wireless link(s) 125 using a communication channel or connection that is outside of the network 115. For example, the network-connectable devices 105A through 105D and the command center 110 communicate directly with each other. Although FIG. 1 only shows direct-mode wireless links 125 between adjacent network-connectable devices 105, in some embodiments, any one of the network-connectable devices 105 and the command center 110 is capable of communicating with another network-connectable device 105 or the command center 110 via a direct-mode wireless link 125.

FIG. 2 is a block diagram of the command center 110 according to one example embodiment. In some embodiments, the command center 110 includes a communication device manager 205 and a plurality of communication devices 210A through 210C that are similar to and may be considered network-connectable devices 105 of FIG. 1 as explained above. In the following description, when explaining how a single communication device functions, a reference to communication device 210 is used. In some embodiments, the communication devices 210 are dispatch consoles that are each operated by a separate dispatcher (for example, public safety dispatch consoles each operated by a separate incident-handling dispatcher as explained above). In some embodiments, the communication device manager 205 is communicatively coupled to the network 115 and to the communication devices 210A through 210C via wired connections, wireless connections, or a combination thereof. As explained in greater detail below, the communication device manager 205 is configured to receive one or more data feeds from one or more network-connectable devices 105 over the network 115. In some embodiments, the communication device manager 205 is configured to control which received data feeds are provided to which communication devices 210 and whether the received data feeds are to be presented on the respective communication devices 210. In some embodiments, the communication devices 210 are configured to communicate through the communication device manager 205 to one or more network-connectable devices 105 over the network 115.

Although the communication devices 210 are described as being located at the command center 110, in some embodiments, the communication devices 210 are portable devices such as the network-connectable devices 105 described above. Additionally, the terms “network-connectable device” and “communication device” are used throughout this specification to explain example use situations. However, a single device, for example, a portable radio of a public safety officer, may be considered a network-connectable device 105 in one situation and may be considered a communication device 210 in another situation.

In some embodiments, the command center 110 includes additional communication devices operated by emergency call-takers that receive one data feed at a time from a queue of data feeds intended for the command center 110. For example, the emergency call-takers are 911 call-takers operating 911 call-taking devices that receive data feeds from citizens who enter 9-1-1 on their network-connectable device 105 to transmit a data feed to the command center 110. In such embodiments, these additional communication devices operated by emergency call-takers may be integrated into the communication device manager 205 or may be communicatively coupled to the communication device manager 205. Similarly, while FIG. 2 shows the communication devices 210 and the communication device manager 205 as separate devices, in some embodiments, the communication devices 210 are integrated into the communication device manager 205 and directly controlled by the communication device manager 205. In other embodiments, the command center 110 may not include a separate communication device manager 205 and the functionality of the communication device manager 205 described below may be integrated into each of the communication devices 210. In some embodiments, the command center 110 includes more or fewer communication devices 210 than the quantity of communication devices 210 shown in FIG. 2.

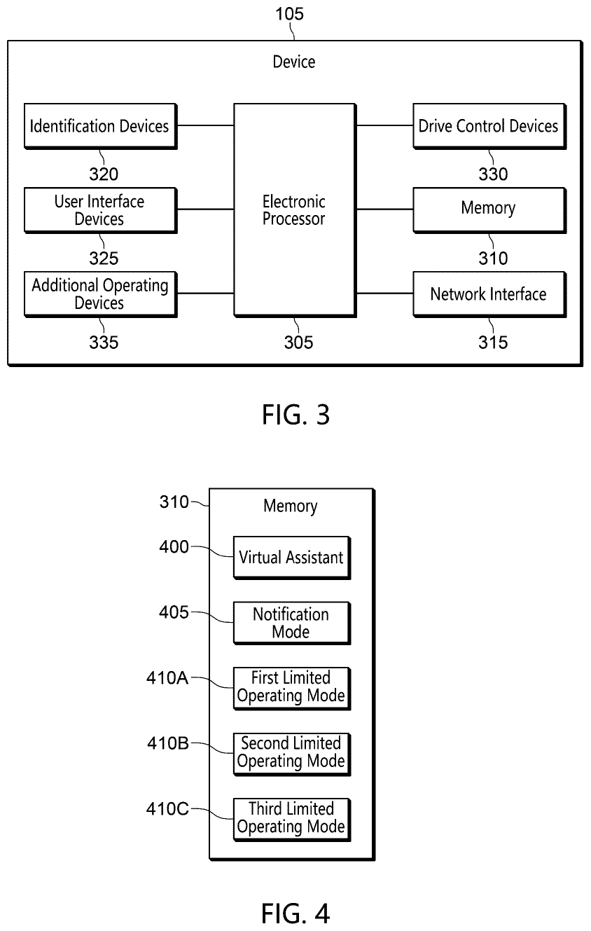

FIG. 3 is a block diagram of an example network-connectable device 105 according to one example embodiment. The device 105 includes an electronic processor 305 connected to a memory 310. The electronic processor 305 is also connected to a network interface 315 (e.g., a transceiver), identification devices 320, user interface devices 325, drive control devices 330, and additional operating devices 335. The electronic processor 305, the memory 310, the network interface 315, the identification devices 320, the user interface devices 325, the drive control devices 330, and the additional operating devices 335 communicate over one or more control and/or data buses. FIG. 3 illustrates only one example of a device 105. The device 105 may include more or fewer components and may perform functions other than those explicitly described herein.

In some examples, the electronic processor 305 is implemented as a microprocessor with separate memory, such as the memory 310. In other examples, the electronic processor 305 may be implemented as a microcontroller (with memory 310 on the same chip). In other examples, the electronic processor 305 may be implemented using multiple processors. In addition, the electronic processor 305 may be implemented partially or entirely as, for example, a field-programmable gate array (FPGA), an applications specific integrated circuit (ASIC), and the like and the memory 310 may not be needed or be modified accordingly. In the example illustrated, the memory 310 includes non-transitory, computer-readable memory that stores instructions that are received and executed by the electronic processor 305 to carry out the functionality of the device 105 described herein. The memory 310 may include, for example, a program storage area and a data storage area. The program storage area and the data storage area may include combinations of different types of memory, such as read-only memory and random-access memory.

The memory 310 stores applications that are executed by the electronic processor 305. In the example illustrated in FIG. 4, the memory 310 stores a virtual assistant 400, notification mode instructions 405, and a plurality of limited operating mode instructions 410. The memory 310 may store additional applications than those illustrated in FIG. 4 to perform the methods described herein.

The virtual assistant 400 is a program that assists in the operation of the device 105. The virtual assistant 400 is executed by the electronic processor 305. The virtual assistant 400 receives user-initiated queries, such as a spoken query, a typed query, or a combination thereof. Using natural language processing on the query, the virtual assistant 400 identifies subject matter of the query and contextual information of the query to process the query. After processing the query, the virtual assistant 400 determines a response to the query, which may be provided via a speaker or a display.

The notification mode instructions 405 defines a set of operations performed by the electronic processor 305 for notifying one or more other network-connectable devices 105 of an event. The event may trigger the device 105 entering the notification mode. When the device 105 enters a notification mode, the electronic processor 305 follows the set of operations defined by the notification mode instructions 405 in the memory 310. The set of operations may include transmitting an alert to other network-connectable devices 105, transmitting an alert to the command center 110, tracking a location of the device 105, restricting incoming or outgoing communications associated with the device 105, notifying other devices within a shared talkgroup of the device 105, and the like.

The plurality of limited operating mode instructions 410 defines a set of operating features that are accessible based on the operating mode of the device 105. For example, during normal operation, the device 105 is fully operable and all features are accessible by the user. When the device 105 enters a limited operating mode, one or more of the features may be disabled, as defined by the associated limited operating mode instructions 410. In the example of FIG. 4, the memory 310 stores a first limited operating mode 410A, a second limited operating mode 410B, and a third limited operating mode 410C. Each limited operating mode 410 may allow access to a different set of operating features (and, therefore, may disable access to different sets of operating features).

In one example, the first limited operating mode 410A allows access to drive control devices 330, but disables access to additional operating devices 335. The second limited operating mode 410B allows access to the additional operating devices 335, but disables access to the drive control devices 330. The third limited operating mode 410C allows access to the drive control devices 330 and the additional operating devices 335, but disables access to the virtual assistant 400. In other examples, the limited operating modes may disable a subset of the drive control devices 330 or disable a subset of the additional operating devices 335. Additionally, in other examples, the memory 310 may store fewer or more limited operating modes 410 than those illustrated.

Returning to FIG. 3, the network interface 315 enables bidirectional wired and/or wireless communication of the device 105 with the other network-connectable devices 105 and the command center 110 over the communication network 115. The user interface devices 325 may be an input/output interface that includes one or more input mechanisms (for example, a touch pad, a keypad, and the like), one or more output mechanisms (for example, a display, a speaker, and the like), or a combination thereof, or a combined input and output mechanism such as a touch screen.

The identification devices 320 are devices that assist with identifying an identity of the user of the device 105 or authenticating the user of the device 105. The identification devices 320 may include a keyboard or touchscreen configured to receive a password, biometric devices (for example, fingerprint scanners, eye scanners, voice recognition devices, and the like), a dash camera, image analysis devices (for example, facial recognition devices), weight sensors, wireless scanners (for example, RFID or NFC scanners, a Bluetooth® communication device), and the like.

In instances where the device 105 is a vehicle (such as the third network-connectable device 105C), the drive control devices 330 are devices associated with driving of the vehicle. For example, the drive control devices 330 include steering control devices (for example, a steering wheel), braking control devices (for example, a brake pedal), acceleration control devices (for example, an acceleration control pedal), and the like. The additional operating devices 335 include additional devices that enable other operating features of the device 105. For example, when the device 105 is a vehicle, the additional operating devices 335 may include an FM radio, a mobile radio, visual indicators, location services, window control, air conditioning, door locks, speaker volume, trunk access, weapon access, vehicle lights, a vehicle siren, and the like.

Example methods described herein primarily refer to the device 105 being a vehicle and, in particular, a public safety vehicle. However, the device 105 may be other types of vehicles, such as tractors, bulldozers, forklifts, delivery trucks, rideshare cars, rental cars, tractors and other heavy equipment, and the like. Accordingly, the additional operating devices 335 may include other features, such as forklift controls, a seed deployment device, a fertilizer deployment device, a mechanized ladder apparatus, and the like. Additionally, the device 105 may be a non-vehicular electronic device, such as a personal mobile phone, a PDA, a tablet device, a portable radio, and the like.

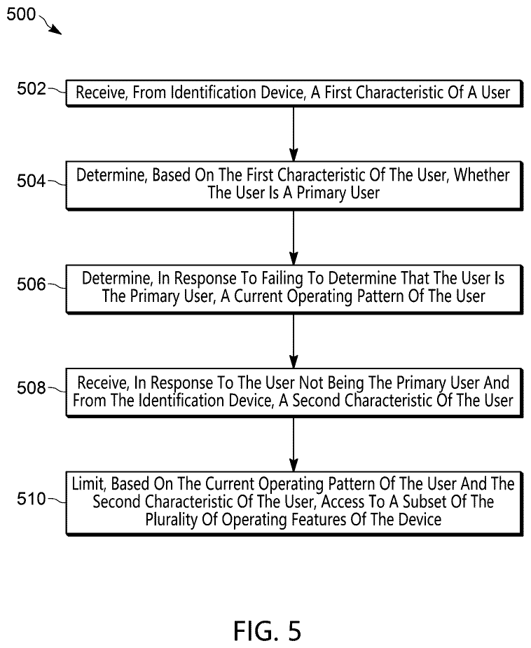

FIG. 5 illustrates one example method 500 for limiting operating features of a device. The method 500 is described as being executed by the electronic processor 305. However, in some examples, aspects of the method 500 may be performed by another processing device. For example, the method 500 may be performed by the electronic processor 305 in conjunction with the communication device manager 205 of the command center 110.

At block 502, the electronic processor 305 receives, from an identification device 320, a first characteristic of a user. For example, the identification devices 320 provides, to the electronic processor 305, an identifying characteristic of a driver within a vehicle. The identifying characteristic may be a fingerprint of the driver, an eye scan of the eyes of the driver, an image of the driver, a weight of the driver, a badge identification number associated with the driver (for example, obtained via an RFID scanner), or the like.

At block 504, the electronic processor 305 determines, based on the first characteristic of the user, whether the user is a primary user. For example, the first characteristic of the driver is compared with known characteristics of the primary driver. At block 506, the electronic processor 305 determines, in response to failing to determine that the user is the primary user, a current operating pattern of the user. For example, the user is determined to be an unauthorized user or a secondary user. As the user is not the primary user, the electronic processor 305 monitors operating patterns of the user and how they operate the vehicle. The operating patterns may include whether the user is driving above the speed limit, whether the user is driving in the correct street lane, whether the user is driving the car along a normal driving route, and the like. In some instances, the electronic processor 305 also monitors operating patterns when the user is the primary user.

At block 508, the electronic processor 305 receives, in response to the user not being the primary user and from the identification device 320, a second characteristic of the user. For example, in response to the user not being the primary user, the electronic processor 305 attempts to authorize the user of the device 105 using a different authentication method. In one instance, the first characteristic is a fingerprint of the driver. In such an instance, the second characteristic may be an image of the driver or the weight of the driver.

At block 510, the electronic processor 305 limits, based on the current operating pattern of the user and the second characteristic of the user, access to a subset of the plurality of operating features of the device. For example, based on the current operating pattern of the user and the second characteristic of the user, the electronic processor 305 selects one of the limited operating modes 410 stored in the memory 310.

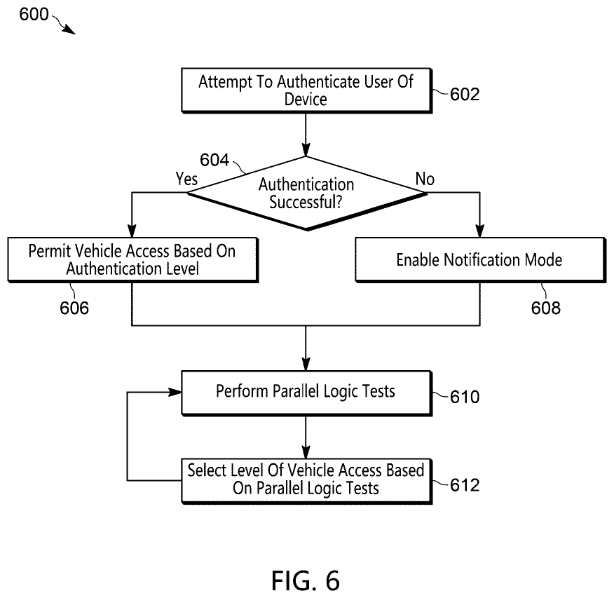

FIG. 6 illustrates another example method 600 for limiting operating features of a device 105. The method 600 is described as being executed by the electronic processor 305. However, in some examples, aspects of the method 600 may be performed by another processing device. For example, the method 600 may be performed by the electronic processor 305 in conjunction with the communication device manager 205 of the command center 110. Certain steps of the method 600 may mirror or be combined with steps of the method 500.

At block 602, the electronic processor 305 attempts to authenticate a user of the device 105. For example, when a driver of a vehicle enters the vehicle, one of the identification devices 320 operate to authorize the driver. In some instances, the identification devices 320 automatically operate upon the driver entering the vehicle. In other instances, the driver of the vehicle is prompted to authenticate their identity after entering the vehicle.

In some implementations, authorization of the user of the device 105 is based on a questionnaire provided to the user. The device 105 may prompt the user with questions associated with historical operation of the device 105. For example, the user may be prompted with questions related to a typical shift start time, a typical street the vehicle is parked on, a typical jurisdiction of the vehicle, and the like.

At block 604, the electronic processor 305 determines whether the authentication is successful (e.g., whether the driver of the vehicle is an authorized driver). When the authentication is successful (e.g., the driver of the vehicle is an authorized driver), the electronic processor 305 proceeds to block 606 and permits vehicle access based on the authentication level. For example, when the driver of the vehicle is authorized as the primary driver, the electronic processor 305 provides full access to all operating features of the vehicle. When the driver of the vehicle is authorized as a secondary driver, the electronic processor 305 provides access to a subset of the operating features of the vehicle. For example, the electronic processor 305 implements one of the plurality of limited operating mode instructions 410 stored in the memory 310.

Returning to block 604, when the authentication is not successful (e.g., the driver of the vehicle is not an authorized driver), the electronic processor 305 proceeds to block 608 and initiates a notification mode. For example, the electronic processor 305 implements the notification mode instructions 405 stored in the memory 310. In an instance where the vehicle is a public safety vehicle and the vehicle is in the notification mode, the electronic processor 305 may transmit an alert to the command center 110 indicating that an unauthorized driver is operating the vehicle. The electronic processor 305 may transmit a location of the vehicle to the command center 110 such that a communication device 210 tracks the location of the vehicle (for example, on a map). When in the notification mode, the electronic processor 305 may restrict incoming communication to the vehicle, may restrict outgoing communication to the vehicle, or may restrict both incoming and outgoing communication to the vehicle. Additionally, when in the notification mode, the electronic processor 305 may transmit a notification to network-connectable devices 105 that are within a talkgroup shared with the vehicle.

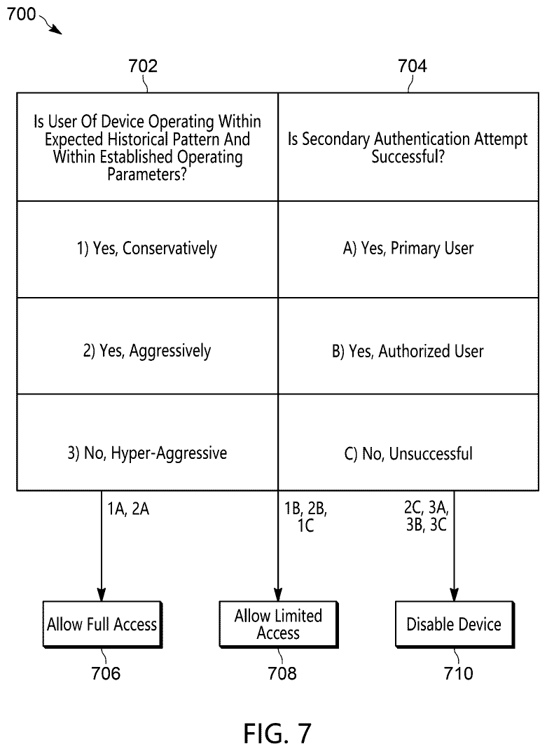

After permitting vehicle access at block 606, or after enabling the notification mode at block 608, the electronic processor 305 proceeds to block 610. At block 610, the electronic processor 305 performs parallel logic tests. FIG. 7 illustrates an example of the parallel logic tests represented as a table 700. At block 702, the parallel logic test 610 includes the electronic processor 305 determining whether a user of the device is operating within an expected historical pattern and is operating within established operating parameters. For example, the electronic processor 305 may observe a driving speed of the vehicle, observe whether the vehicle is being driven within the appropriate street lanes, observe whether the vehicle is taking sharp turns, observe whether the vehicle is experiencing a hard braking, and the like.

The results of block 702 may be either “Yes, Conservatively” (1), “Yes, Aggressively (2), or “No, Hyper-Aggressive” (3). These represent scales of how well the device 105 is being operated within the expected historical pattern and within the established operating parameters. For example, “conservative” (1) operation may include the vehicle being driven within 10 miles per hour of the speed limit and using the appropriate lanes at least 90% of the time. As another example, the number of sharp turn events is compared to a threshold, such as the number of sharp turns per hour. When the number of sharp turns per hour is less than the threshold (for example, less than two sharp turns per hour), the driving is determined as conservative. In yet another example, the number of hard braking events is compared to a threshold, such as the number of hard braking events per hour. When the number of hard braking events is less than the threshold (for example, less than two hard braking events per hour), the driving is determined as conservative. Hard braking events may be, for example, a single braking event with a deceleration greater in magnitude than −0.5 g.

In some instances, the expected historical pattern is a recorded driving pattern of the primary user. For example, the expected historical pattern may be a typical driving route of the primary user, a typical driving speed of the primary user related to the speed limit (e.g., a range of speeds around the speed limit), and the like. The established operating parameters may be hard limits placed on the device 105. For example, a maximum speed limit may be placed on the device 105, or operation of the device 105 may be limited to within a geofence. In another example, the expected historical pattern is an aggregate (or average) expected driving pattern of the primary user and other users within a similar network of the primary user (for example, peers such as officer and/or co-workers in a similar role as the primary user).

“Aggressive” (2) operation includes the vehicle being driven above the thresholds associated with “conservative” (1) operation, but less than thresholds associated with “hyper-aggressive” (3) operation. For example, when the number of sharp turns per hour is greater than two but less than four the driving is determined as aggressive. When the number of hard braking events is greater than two but less than four the driving is determined as aggressive. The vehicle may be driven more than 10 miles per hour over the speed limit but less than 15 miles per hour over the speed limit. As another example, the vehicle is driven within the appropriate lanes at least 75% of the time but less than 90% of the time.

“Hyper-Aggressive” (3) operation includes the vehicle being driven above the thresholds associated with “aggressive” (2) operation. For example, when the number of sharp turns per hour is greater four the driving is determined as hyper-aggressive. When the number of hard braking events is greater four the driving is determined as hyper-aggressive. The vehicle may be driven more than 15 miles per hour over the speed limit. As another example, the vehicle is driven within the appropriate lanes less than 75% of the time. Additionally, the vehicle may stray from operational boundaries, miss stops (e.g., drive through red lights or stop signs), be driven off-schedule, be driven on the wrong route, drive significantly under the speed limit, stop in the middle of a roadway, and the like. Hyper-aggressive operation may indicate that the vehicle has been stolen, that the driver is impaired, or other similar situations.

These expected operating parameters may differ for situational purposes. For example, expected operation of a public safety vehicle is different depending on whether the public safety vehicle is patrolling, responding to an emergency, or pursuing another vehicle. Similarly, commercial or heavy machinery may have different expected operating parameters based on the task being performed. Accordingly, thresholds described herein may be established for each separate task.

The expected operating parameters and expected historical patterns may be stored by the command center 110. In such an instance, the electronic processor 305 communicates with the command center 110 to perform block 702, or block 702 may be determined by a processor associated with the command center 110.

At block 704, the parallel logic test 610 includes the electronic processor 305 determining whether a secondary authentication attempt is successful. For example, after determining whether the authentication is successful at block 604, the electronic processor 305 continues to check the authentication of the user. The secondary authentication attempt may be using the same identification method as used at block 604, or may use a different identification method of the identification devices 320.

As one example, an unauthorized driver enters the vehicle. When the unauthorized driver enters the vehicle, the electronic processor 305 attempts to (and fails to) authenticate the driver. In one instance, the first authentication attempt (at block 604) includes comparing a fingerprint of the driver to stored fingerprints of authorized drivers. In such an instance, the second authentication (at block 704) may include analyzing an image of the driver to identify the driver. The electronic processor 305 may determine that the user is the primary user (A), that the user is a secondary authorized user (B), or that the user is an unauthorized user (C).

Returning to FIG. 6, at block 612, the electronic processor 305 selects a level of vehicle access based on the parallel logic tests. For example, with reference to FIG. 7, when the electronic processor 305 determines that the vehicle is being operated with “conservative” operation by the primary user (1A), or that the vehicle is being operated with “aggressive” operation by the primary user (2A), the electronic processor 305 allows full access to the operating features of the device 105 (at block 706).

When the electronic processor 305 determines that the vehicle is being operated with “conservative” operation by a secondary authorized user (1), the vehicle is being operated with “aggressive” operation by the secondary authorized user (2B), or that the vehicle is being operated with “conservative” operation by an unauthorized user (1C), the electronic processor 305 allows limited access to the operating features of the device 105 (at block 708). For example, when the operating pattern of the vehicle is “aggressive” or “hyper-aggressive” (1, 1C), then in some cases, an approved but unexpected user may need to access the vehicle. For example, a police officer that is not the typical driver of a public safety vehicle may need access to the public safety vehicle, or a firefighter may need to unexpectedly drive an ambulance. In these situations, the drive control devices 330 may be enabled while additional operating devices 335 and/or the virtual assistant 400 are disabled. In some instances, the electronic processor 305 selects one of the plurality of limited operating modes 410 based on the identity of the secondary authorized user. In some instances, the electronic processor 305 determines the secondary authorized user has full access to the vehicle.

When the electronic processor 305 determines that the vehicle is being operated with “aggressive” operation by an unauthorized user (2C), or that the vehicle is being operated with “hyper-aggressive” operation by any user (3A, 3B, 3C), the electronic processor 305 disables the device (at block 710).

In some instances, the electronic processor 305 also enters the notification mode when operation of the device 105 is limited or disabled. The notification mode may be maintained until the primary user becomes the driver. In this manner, in instances where the device 105 is a public safety vehicle, the command center 110 may be continuously notified when a secondary user or unauthorized user is accessing the public safety vehicle.

After selecting the level of vehicle access (at block 612), the electronic processor 305 returns to block 610 and continues to perform the parallel logic tests. In this manner, the electronic processor 305 repeatedly monitors the identity of the driver and the operating pattern of the driver to ensure that only permitted operating features of the device 105 are accessible. For example, there may be an instance where a primary driver of a public safety vehicle leaves the public safety vehicle unattended but continuing to run. In such an instance, the electronic processor 305 would detect whether an unauthorized user attempts to access the public safety vehicle.

### Example Use Cases

In one example, a person of interest attempts to steal a police vehicle during an emergency evacuation. Upon entering the police vehicle, the vehicle determines that the person of interest is an unauthorized user and disables all operating features of the vehicle. Additionally, the vehicle enters notification mode and transmits an alert to the command center 110 and nearby police officers.

In another example, a mechanic working on a police vehicle is authorized but has limited access to the police vehicle. The drive control features are enabled, but the maximum speed of the police vehicle is limited and the mechanic cannot operate lights, sirens, or the mobile radio.

In another example, a tractor implements the methods described herein. When in a limited operating mode, limited operation of the tractor provides for driving the tractor at slow speed and only within a geofence, while operating features related to harvesting, such as cutting, plowing, tilling, and dispensing of seed or fertilizer, are disabled.

In yet another example, a forklift implements the methods described herein. Forklifts are expensive resources with complex controls that require training to operate and may create significant damage if operated inappropriately and/or by unauthorized users. Accordingly, trained users may become authorized users such that only trained users can operate the forklift.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example examples may be written in an object oriented programming language such as Java, Smalltalk, C++, Python, or the like. However, the computer program code for carrying out operations of various example examples may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for controlling use of a device having a plurality of operating features based on authentication of a user, the system comprising:
an identification device configured to identify characteristics of the user of the device; and
an electronic processor communicatively coupled to the identification device, the electronic processor configured to:
receive, from the identification device, a first characteristic of the user,
determine, based on the first characteristic of the user, whether the user is a primary user,
determine, in response to failing to determine that the user is the primary user, a current operating pattern of the user,
receive, in response to the user not being the primary user and from the identification device, a second characteristic of the user, and
limit, based on the current operating pattern of the user and the second characteristic of the user, access to a subset of the plurality of operating features of the device.

2. The system of claim 1, wherein the electronic processor is further configured to:
permit, in response to the user being the primary user, access to all of the plurality of operating features of the device,
determine a current operating pattern of the user, and
limit, based on the current operating pattern of the user, a first operating feature of the plurality of operating features of the device.

3. The system of claim 1, wherein the electronic processor is further configured to:
initiate, in response to the user not being the primary user, a notification mode, in which the electronic processor performs at least one action included in the group consisting of: transmitting, with a transceiver, a notification to a server, transmitting, with the transceiver, the notification to a second device, transmitting, with the transceiver, the notification to a mobile device, and restricting incoming and outgoing transmissions.

4. The system of claim 1, wherein the device is a vehicle and, to determine the current operating pattern of the user, the electronic processor is configured to:
determine a driving speed of the vehicle, and
compare the driving speed of the vehicle to an expected driving speed of the vehicle to generate an operating difference value, wherein the expected driving speed is based on historical driving patterns of an average user of the vehicle.

5. The system of claim 1, wherein the plurality of operating features includes at least two selected from the group consisting of steering control, acceleration control, braking control, control of a visual indicator, access to a virtual assistant, access to a location service, radio control, window control, ventilation control, door lock control, access to vehicle lights, access to a vehicle siren, access to a trunk, access to a mechanized ladder apparatus, access to a seed deployment device, access to a fertilizer deployment device, access to forklift controls, and volume control of a speaker.

6. The system of claim 1, wherein the identification device includes at least one selected from the group consisting of a fingerprint scanner, a camera, a microphone, a weight sensor, an RFID scanner, a keypad, and a touch screen.

7. The system of claim 1, wherein, to limit the subset of the plurality of operating features, the electronic processor is configured to:
select, based on the current operating pattern of the user and the second characteristic of the user, one of a first limited operating mode and a second limited operating mode, wherein the first limited operating mode permits more of the plurality of operating features than the second limited operating mode.

8. The system of claim 1, wherein, to limit the subset of the plurality of operating features, the electronic processor is configured to:
limit a maximum speed of the device, and
limit access to a device virtual assistant.

9. The system of claim 1, wherein the electronic processor is further configured to:
determine, based on the current operating pattern of the user and the second characteristic of the user, whether the user is an unauthorized user, and
disable, in response to the user being the unauthorized user, the device.

10. The system of claim 1, wherein the electronic processor is further configured to:
determine, after limiting the subset of the plurality of operating features and based on the second characteristic of the user, whether the user is the primary user and whether the user is operating the device within established operating parameters, and
permit, in response to the user being the primary user and the user operating the device within established operating parameters, the subset of the plurality of operating features.

11. A method for controlling use of a device having a plurality of operating features based on authentication of a user, the method comprising:
receiving, from an identification device configured to identify characteristics of the user of the device, a first characteristic of the user;
determining, based on the first characteristic of the user, whether the user is a primary user;
determining, in response to failing to determine that the user is the primary user, a current operating pattern of the user;
receiving, in response to the user not being the primary user and from the identification device, a second characteristic of the user; and
limiting, based on the current operating pattern of the user and the second characteristic of the user, access to a subset of the plurality of operating features of the device.

12. The method of claim 11, further comprising:
permitting, in response to the user being the primary user, access to all of the plurality of operating features of the device,
determining a current operating pattern of the user, and
limiting, based on the current operating pattern of the user, a first operating feature of the plurality of operating features of the device.

13. The method of claim 11, further comprising:
initiating, in response to the user not being the primary user, a notification mode of the device, wherein, when the device is in the notification mode, the method includes at least one of:
transmitting, with a transceiver, a notification to a server;
transmitting, with the transceiver, the notification to a second device;
transmitting, with the transceiver, the notification to a mobile device; and
restricting incoming and outgoing transmissions.

14. The method of claim 11, wherein the device is a vehicle, and wherein determining the current operating pattern of the user includes:
determining a driving speed of the vehicle; and
comparing the driving speed of the vehicle to an expected driving speed of the vehicle to generate an operating difference value, wherein the expected driving speed is based on historical driving patterns of an average user of the vehicle.

15. The method of claim 11, wherein the plurality of operating features includes at least two selected from the group consisting of steering control, acceleration control, braking control, control of a visual indicator, access to a virtual assistant, access to a location service, radio control, window control, ventilation control, door lock control, and volume control of a speaker.

16. The method of claim 11, wherein the identification device includes at least one selected from the group consisting of a fingerprint scanner, a camera, a microphone, a weight sensor, an RFID scanner, a keypad, and a touch screen.

17. The method of claim 11, wherein limiting the subset of the plurality of operating features includes:
selecting, based on the current operating pattern of the user and the second characteristic of the user, one of a first limited operating mode and a second limited operating mode, wherein the first limited operating mode permits more of the plurality of operating features than the second limited operating mode.

18. The method of claim 11, wherein limiting the subset of the plurality of operating features includes:
limiting a maximum speed of the device; and
limiting access to a device virtual assistant.

19. The method of claim 11, further comprising:
determining, based on the current operating pattern of the user and the second characteristic of the user, whether the user is an unauthorized user; and
disabling, in response to the user being the unauthorized user, the device.

20. The method of claim 11, further comprising:
determining, after limiting the subset of the plurality of operating features and based on the second characteristic of the user, whether the user is the primary user and whether the user is operating the device within established operating parameters; and
permitting, in response to the user being the primary user and the user operating the device within established operating parameters, the subset of the plurality of operating features.
